(19) United States
(12) Patent Application Publication
(10) Pub. No.: US 2019/0222137 A1
(43) Pub. Date: Jul. 18, 2019

(54) BULK CAPACITOR INRUSH CURRENT LIMITING CIRCUIT

(71) Applicant: GM Global Technology Operations LLC., Detroit, MI (US)

(72) Inventor: SM Nayeem Hasan, Novi, MI (US)

(21) Appl. No.: 15/869,534

(22) Filed: Jan. 12, 2018

(51) Int. Cl. H02M 7/06; H02M 7/12; G05F 1/10; H02H 9/00; H02M 1/08

(52) U.S. Cl. CPC H02M 7/062; H02M 7/125; H02M 1/08; H02H 9/001; G05F 1/10

(57) ABSTRACT

A circuit with limited inrush current includes a bulk capacitor and an isolation switch electrically connected to the bulk capacitor. A current through the isolation switch has a linear profile over a time period prior to the charging of the bulk capacitor so that a predetermined initial charging current flows into the bulk capacitor at the beginning of the charging of the bulk capacitor.

The present disclosure relates to a circuit that limits bulk capacitor inrush current.

In a typical circuit with a bulk capacitor, the charging of the bulk capacitor during the start-up of the circuit generates a surge current, which is also known as an inrush current.

For example, a battery input circuit of a transmission control module (TCM) and engine control module (ECM) has filters that include inductors and bulk capacitors. The TCM/ECM circuits are isolated from the battery input through an isolation switch such as a MOSFET. When the isolation switch is turned on, a high inrush current flows to the bulk capacitor. This scenario occurs on every on cycle. The high inrush current ultimately damages the dielectric material of the electrolytic capacitors, which causes the capacitors to fail.

Techniques have been employed to reduce the effects of an inrush current on bulk capacitors. For example, some circuits employ a pre-charge circuit. Such pre-charge circuits, however, add complexity and expense to the overall circuit.

Thus, while current inrush limiters achieve their intended purpose, there is a need for a new and improved circuits that limit the inrush current to the bulk capacitor.

### SUMMARY

According to several aspects, a circuit with limited inrush current includes a bulk capacitor and an isolation switch electrically connected to the bulk capacitor. A current through the isolation switch has a linear profile over a time period prior to the charging of the bulk capacitor so that a predetermined initial charging current flows into the bulk capacitor at the beginning of the charging of the bulk capacitor.

In an additional aspect of the present disclosure, the initial charging current is less than a peak inrush current to the bulk capacitor.

In another aspect of the present disclosure, the peak inrush current occurs when the isolation switch is fully on.

In another aspect of the present disclosure, the isolation switch is a P-MOSFET.

In another aspect of the present disclosure, the circuit includes a N-MOSFET electrically connected to the P-MOSFET, the N-MOSFET driving the P-MOSFET as the N-MOSFET receives a gate voltage.

In another aspect of the present disclosure, a current through the N-MOSFET has a linear profile over a time period.

In another aspect of the present disclosure, the time period the current through the P-MOSFET has the linear profile is the same as the time period the current through the N-MOSFET has the linear profile.

In another aspect of the present disclosure, a predetermined slew rate of the gate voltage is applied to the N-MOSFET so that the current through the N-MOSFET and the current through the P-MOSFET both have linear profiles.

In another aspect of the present disclosure, the bulk capacitor has a plurality of capacitors.

In another aspect of the present disclosure, the plurality of capacitors is three capacitors.

According to several aspects, a circuit with limited inrush current includes a bulk capacitor, a P-MOSFET electrically connected to the bulk capacitor, and a N-MOSFET electrically connected to the P-MOSFET. The N-MOSFET drives the P-MOSFET as the N-MOSFET receives a gate voltage. A current through the N-MOSFET has a linear profile over a time period, and a current through P-MOSFET has a linear profile over a time period prior to the charging of the bulk capacitor so that a predetermined small initial charging current flows into the bulk capacitor at the beginning of the charging of the bulk capacitor.

In an additional aspect of the present disclosure, the time period the current through the P-MOSFET has the linear profile is the same as the time period the current through the N-MOSFET has the linear profile.

In another aspect of the present disclosure, a predetermined slew rate of the gate voltage is applied to the N-MOSFET so that the current through the N-MOSFET and the current through the P-MOSFET both have linear profiles.

In another aspect of the present disclosure, the initial charging current is less than a peak inrush current to the bulk capacitor.

In another aspect of the present disclosure, the peak inrush current occurs when the P-MOSFET is fully on.

In another aspect of the present disclosure, the bulk capacitor has a plurality of capacitors.

In another aspect of the present disclosure, the plurality of capacitors is three capacitors.

According to several aspects, a circuit with limited inrush current includes a bulk capacitor, a P-MOSFET electrically connected to the bulk capacitor, and a N-MOSFET electrically connected to the P-MOSFET. The N-MOSFET drives the P-MOSFET as the N-MOSFET receives a gate voltage. A current through the N-MOSFET has a linear profile over a time period, and a current through P-MOSFET has a linear profile over a time period prior to the charging of the bulk capacitor so that a predetermined initial charging current flows into the bulk capacitor at the beginning of the charging of the bulk capacitor. The time period the current through the P-MOSFET has the linear profile is the same as the time period the current through the N-MOSFET has the linear profile.

In an additional aspect of the present disclosure, the initial charging current is less than a peak inrush current to the bulk capacitor.

In another aspect of the present disclosure, the peak inrush current occurs when the P-MOSFET is fully on.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 shows a circuit that limits bulk capacitor inrush current in accordance with the principles of the present disclosure;

FIG. 2 shows simulations of the circuit shown in FIG. 1; and

FIG. 3 shows simulations of a circuit without limitations to the bulk capacitor inrush current.

### DETAILED DESCRIPTION

The following description is merely exemplary in nature and is not intended to limit the present disclosure, application, or uses.

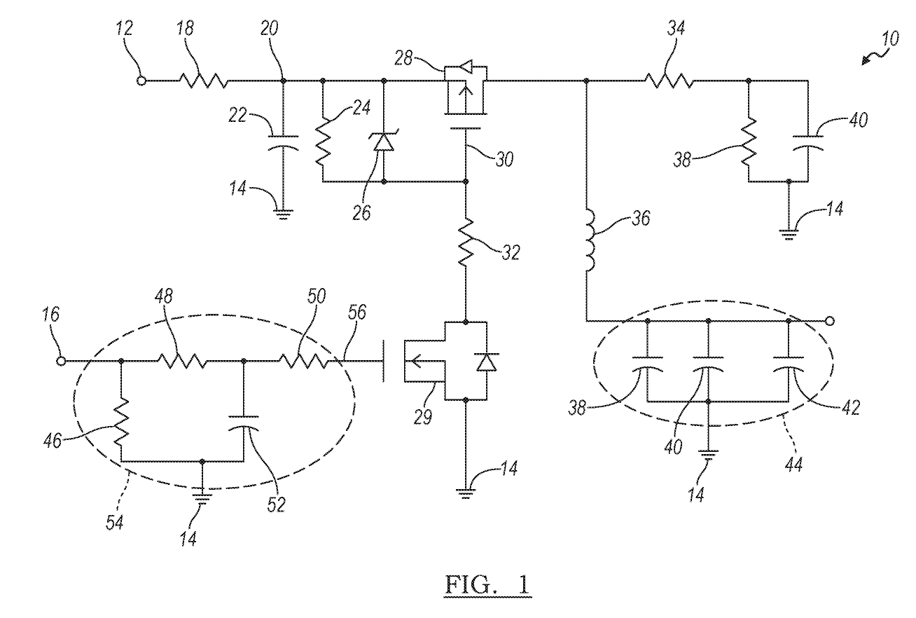

Referring to FIG. 1, there is shown a circuit 10 with bulk capacitor inrush limiting capabilities. The circuit 10 is connected to a ground 14 and receives a battery voltage 12 as well as a gate voltage 16.

The circuit 10 includes a resistor 18 that represents the wiring harness resistance connected to a capacitor 22 at a junction 20. The capacitor 22 is connected to the ground 14. A first gate drive circuit is connected to the junction 20 and includes a resistor 24 and a diode 26 connected to an isolation switch such as a P-MOSFET 28 such that the P-MOSFET receives a gate voltage at 30.

A second drive circuit 54 includes resistor 46, a resistor 48, a resistor 50 and a capacitor 52 connected to the ground 14 and a N-MOSFET 29, which is a driver for the P-MOSFET 28. The N-MOSFET 29 is connected to the ground 14 and receives a gate voltage at 56. The P-MOSFET 28 and the N-MOSFET 29 are connected to each other through a resistor 32.

The circuit 10 further includes a resistor 34 connected to another resistor 38 and a capacitor 40. The resistor 38 and the capacitor 40 are in turn connected to the ground 14. The P-MOSFET 28 is connected through filter inductance 36 to a bulk capacitor 44 which in turn is connected to the ground 14. The bulk capacitor 44 includes a set of three capacitors 38, 40 and 44.

In a particular embodiment, the capacitor 38 is a 10 nF capacitor, the capacitor 40 is a 680 μF capacitor, and the capacitor 42 is a 680 μF capacitor. The resistor 18 is a 100 ma resistor that represents the wiring harness resistance between the battery and controller input pin or junction 20. The resistors 46, 48 and 50 in the second drive circuit 54 are 10 kΩ, 20 kΩ and 1 kΩ resistors, respectively. The capacitor 52 is a 4.5 μF capacitor.

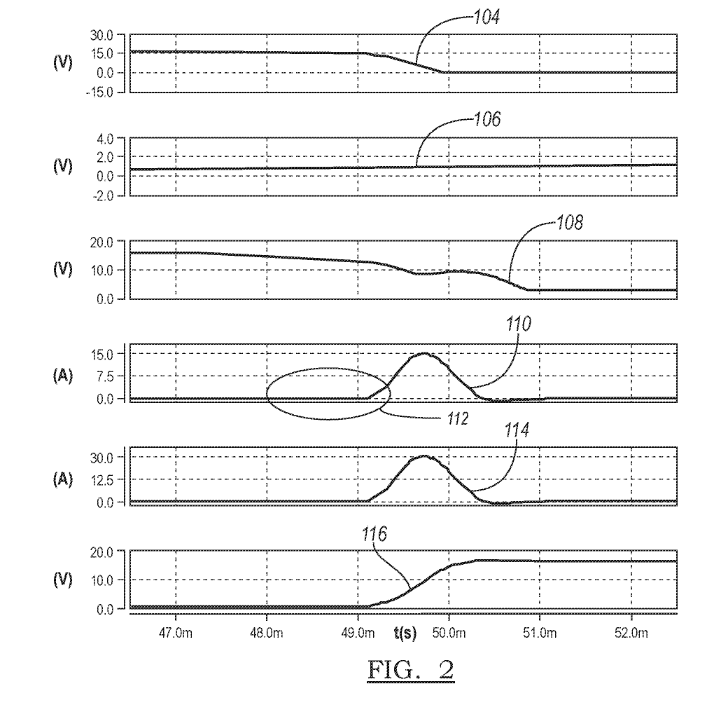

Referring further to FIG. 2, a set of simulations for the circuit 10 with bulk capacitor inrush current limiting capabilities is shown for a battery voltage of 16 V and an ambient temperature of 125° C. Starting from the top, the drive voltage to the P-MOSFET 28 is indicated by the graph 104. The gate voltage at 56 to the N-MOSFET 29 is indicated by the graph 106 and the gate voltage at 30 to the P-MOSFET 28 is indicated by the graph 108. The inrush current to each of the capacitors 40 and 42 is indicated by the graph 110, and the inrush current at the junction 20 is indicated by the graph 114. The voltage on the bulk capacitor 44 is indicated by the graph 116.

Accordingly, when a gate signal is applied to the N-MOSFET 29, the gate voltage 106 on the N-MOSFET 29 rises slowly. The slew rate is determined by the design of the first and the second drive circuits for the P-MOSFET 28 and the N-MOSFET 29 to put the N-MOSFET 29 and the P-MOSFET 28 in the linear region at the beginning of the charging to the bulk capacitor 44, for example, before approximately 49.3 msec in the graphs 106 and 108 for a brief amount of time (approximately 1.3 msec). In this brief amount of time, the gate voltages at 30 and 56 are kept below the fully ON thresholds of the P-MOSFET 28 and the N-MOSFET 29 so that a sub-threshold current flows as indicated by the graph 110. The period of linearity of the P-MOSFET 28 and the N-MOSFET 29 is approximately 1.3 msec and the total charging time is about 2.5 msec. The end of the linear profile is indicated by the inrush current 110 in the region 112. As the gate voltage at 30 decreases towards zero, the P-MOSFET 28 fully turns on. The maximum inrush current at the junction 20 is about 30 A, as indicated by the graph 114, and the maximum inrush current to each bulk capacitor 44 is about 15 A.

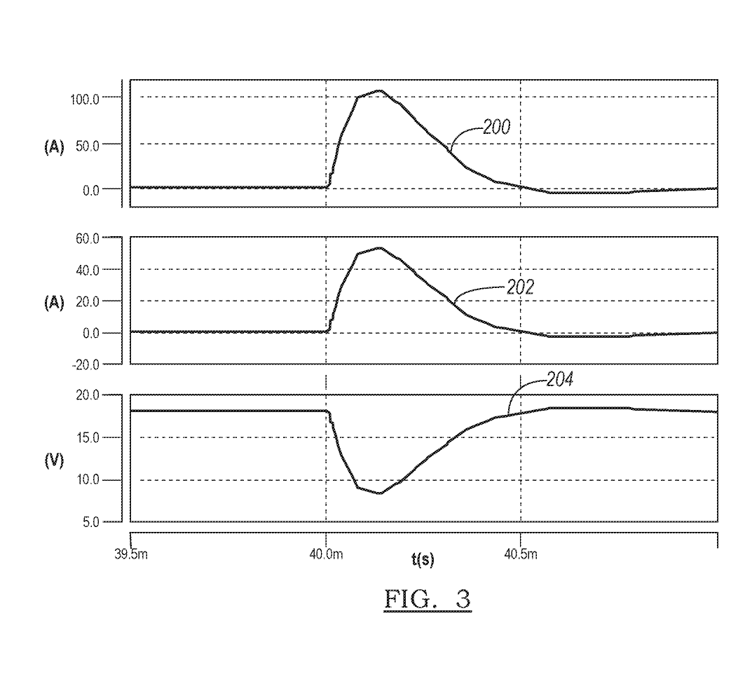

For the sake of comparison, FIG. 3 shows a set of simulations for the circuit without employing inrush current limitations. The inrush current at the junction 20 is indicated by the graph 200. The inrush current to each bulk capacitor 44 is indicated by the graph 202. And the voltage at the junction 20 is indicated by the graph 204.

Without placing the N-MOSFET 29 in the linear region as described above, the P-MOSFET 28 turns on fully at the beginning of the charging of the of the bulk capacitor 44. Hence, the inrush current at the junction 20 exceeds 100 A, which the inrush current to each bulk capacitor 44 exceeds 50 A.

Accordingly, a bulk capacitor inrush current limiter of the present disclosure significantly reduces the maximum inrush current to the bulk capacitor 44 during each turn-on cycle. This eliminates or reduces the damage to the dielectric material of the bulk capacitor, which in turn reduces expenses associated with repairing or replacing the circuit 10. Further, the circuit 10 eliminates the need for a pre-charge circuit, which also reduces costs of the circuit 10.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1.-10. (canceled)

11. A circuit with limited inrush current comprising:
a bulk capacitor;
a P-MOSFET electrically connected to the bulk capacitor and a first drive circuit, the first drive circuit including a first resistor connected in parallel to a diode; and
a N-MOSFET electrically connected to the P-MOSFET and a second drive circuit, the N-MOSFET driving the P-MOSFET as the N-MOSFET receives a gate voltage, the second drive circuit including a second resistor connected in parallel to a first capacitor and a third resistor connected in series to a fourth resistor,
wherein the gate voltage at the N-MOSFET increases linearly and a gate voltage at the P-MOSFET decreases linearly as an inrush current through the P-MOSFET to the bulk capacitor increases linearly over a time period at the beginning of a charging of the bulk capacitor so that a predetermined initial charging current flows into the bulk capacitor at the beginning of the charging of the bulk capacitor.

12.-13. (canceled)

14. The circuit of claim 11 wherein the predetermined initial charging current is less than a peak inrush current to the bulk capacitor.

15. The circuit of claim 14 wherein the peak inrush current occurs when the P-MOSFET is fully on.

16. The circuit of claim 11 wherein the bulk capacitor has a plurality of capacitors.

17. The circuit of claim 16 wherein the plurality of capacitors is three capacitors.

18.-20. (canceled)
